(19) United States
(12) Patent Application Publication
(10) Pub. No.: US 2011/0187357 A1
(43) Pub. Date: Aug. 4, 2011

(54) Magnetic position encoder

(75) Inventors: Klaus Manfred Steinich, Zorneding (DE); Peter Wirth, Eching (DE)

(73) Assignee: ASM AUTOMATION SENSORIK MESSTECHNIK GMBH

(21) Appl. No.: 12/802,758

(22) Filed: Jun. 14, 2010

(30) Foreign Application Priority Data
Jun. 17, 2009 (DE) 20 2009008372.1
Jul. 21, 2009 (DE) 20 2009009919.9
Sep. 3, 2009 (DE) 20 2009011983.1

(51) Int. Cl. G01B 7/30

(52) U.S. Cl. 324/207.25

(57) ABSTRACT

Magnetic position encoders for magnetic angle sensors generally comprise two encoder magnets, which are symmetrically arranged on a base plate. According to the invention, these encoder magnets including the base plate are encased through injection molding. For this purpose, the base plate is configured as a sheet metal stamped part with stop ears which are folded upward, however, they are only folded upward at the ends of the magnets in order not to distort the information of the magnetic field excessively.

### CROSS-REFERENCE TO RELATED APPLICATIONS

This application claims priority to German Patent Application No. 20 2009 011 983.1 filed Sep. 3, 2009.

### FIELD OF THE INVENTION

The invention relates to magnetic position encoders as they are required for actuating magnetically sensitive angle sensors, thus e.g. Wiegand sensors, AMR sensors, GMR sensors, Multi-Magnetic-Domain sensors, Multiturn-Magnetic-Bubbel sensors etc.

Thus, the magnetic position sensor is fixated at the component, whose angular position or rotation position is to be detected by the magnetically sensitive angle sensor, which is to be mounted opposite to the magnetic position encoder and offset there from.

In the simplest case a magnet configured as a position encoder can be fixated through gluing at the component to be detected.

### BACKGROUND OF THE INVENTION

However, since a magnetic field, which is as symmetrical as possible about the rotation axis, has to be generated in order to obtain optimum measurement precision, practical applications often do not use a one-piece permanent magnet, but two permanent magnets disposed opposite to one another with respect to the rotation axis.

In order for the assembly process to be simple and precise, these two encoder magnets are not fixated one by one at the object to be detected, but they are preassembled on a base body, which then has to be fixated in a defined manner at the component to be detected.

For example, it is already known to glue the two encoder magnets onto a sheet metal plate and to fixate them at the component through a central mounting bore hole, which is disposed between the two encoder magnets.

Also folding the base plate by 90° at the outer edge in order to provide a stop for the magnet disposed on the base plate is known, however, the continuous sheet metal stop extending over the entire length of the magnet distorts the configuration of a magnetic field which is symmetrical to an axis of rotation, since the stop is made from a magnetically conductive material.

### BRIEF SUMMARY OF THE INVENTION

Thus, it is the object of the invention to provide a magnetic position encoder of this type, which can be manufactured and mounted with a defined positioning in spite of the simple and cost-effective configuration and still provides a good, in particular mechanical protection for the encoder magnets and which facilitates as many different assembly situations as possible.

This object is accomplished through the features of claims 1 and 3. Advantageous embodiments can be derived from the dependent claims.

On the one hand side, this can be accomplished by using a formed part made from ferromagnetic material, in particular a sheet metal stamped part, in particular made from magnetically conductive sheet metal, as a base plate for applying the at least one encoder magnet.

A stamped part of this type can be produced in a very cost-effective manner, wherein stamping and folding e.g. of stops for the magnets for exact positioning of the encoder magnets can be performed in a single process.

Though the encoder magnets are glued to the base plate as a base body as it is known in the art, however, the gluing with the stops provided by the folded up ears is only for pre-fixation, whereas the actual fixation and simultaneously the protection for the encoder magnets is performed through subsequent insertion of the base plate with the glued down encoder magnets into an injection mold and encasement with plastic material.

Thus, the plastic material covers essentially the entire top side of the base plate and thus entirely encases the encoder magnets besides their bottom sides, through which the magnets are glued to the top side of the base plate and the plastic material preferably also covers the entire base plate besides bottom side.

The form locked stops configured as folded up ears of the base plate also prevent the encoder magnets from getting shifted by the liquid plastic material injected under high pressure.

The form locked stops can thus be edge portions of the base plate which are folded up, wherein the edge portions are then folded up preferably by more than 90°, e.g. by 90° to 100°, so that the interior angle, to which the at least one encoder magnet is then applied, becomes smaller than 90°, so that the encoder magnet contacts this ear only with the top edge of the encoder magnet.

The form locked stops can thus also be configured as beads, which are pressed up from the plane of the base plate.

For this purpose the injection orifices for the plastic material are positioned in the injection mold, so that the plastic material presses the magnets against the stop ears when it flows into the mold, thus the injection orifice(s) for the plastic material is/are disposed radially within the encoder magnets, thus towards the center of the base plate.

Another measure for increasing the assembly options is comprised in that the base plate does not only have one center mounting bore hole, but one, better two additional eccentric mounting bore holes which are disposed opposite and than symmetrical to one another about a center mounting bore hole and which preferably have the same diameter as the center mounting bore hole.

Thus, a user is at liberty to bolt the base plate to the desired component torque proof through the two eccentric mounting bore holes, or only through the center mounting bore hole, which is preferred when bolting it to the face of thin shafts.

Then, however, an additional form locked rotation safety is required, which includes preferable a form locked assembly marker, e.g. a cut out in the circumference of the base plate, in particular proximal to one of the magnets.

In this recess then a respective protrusion at the supporting component can be disposed for rotation safety, wherein this assembly marker simultaneously indicates, how the magnet positioned thereon is polarized or positioned.

The at least one, better the two encoder magnets are preferably configured as elongated cuboids and disposed parallel and symmetrically opposed to one another and arranged on the base plate parallel to the center line of the base plate, wherein the center line is defined by the three mounting bore holes disposed in line.

Of course, two shorter encoder magnets can be applied behind one another instead of one elongated encoder magnet, however, this mainly increases the assembly complexity, without being of large benefit.

Thus, the polar axis of each encoder magnet extends transversal, in particular perpendicular to the main plane of the base plate.

The stop ear folded up from the base plate as a radial outer stop for the encoder magnets, thus is no stop extending over the entire length of the magnet, but only a stop ear at the beginning and at the end of the magnet, which extends over all over a maximum of 15%, better only 10% of the length of the encoder magnet, since the magnetic field formed by the encoder magnets is the more distorted through these retaining ears made of magnetically conductive sheet metal, the larger the retaining ears are.

In order to correctly arrange the magnets with respect to their magnetic polarity when they are applied to the base plate, a preferably also form locked preliminary marker is additionally disposed on the base plate, wherein the preliminary marker may also be identical with the assembly marker, preferably however, the preliminary marker is positioned and configured differently than the assembly marker.

The preliminary marker can also be a recess of the outer contour of the base plate proximal to one of the magnets again, wherein the recess, however, is configured and/or sized differently then.

The outer contour of the base plate includes at least circle segments, wherein the portions of the circumferential contour, which differ from the circle segments do not extend beyond the enveloping circle formed by the circle segments, wherein the enveloping circle is disposed preferably concentric with the center mounting bore hole.

The plastic material for encasing the base plate and the encoder magnet through injection molding can be transparent in order to recognize the magnets therein.

The plastic material leaves at least the assembly marker open and also a circumferential peripheral portion on the top side of the base plate respectively extending about the mounting bore holes, wherein the peripheral portion has to be large enough in order to press the head of a mounting bolt against the top side of the base plate.

### BRIEF DESCRIPTION OF THE DRAWINGS

Embodiments of the invention are subsequently described in more detail with reference to the drawing figure wherein:

FIG. 1: illustrates the base plate;

FIG. 2: illustrates the position encoder still without the plastic encasement;

FIG. 3: illustrates the completed position encoder; and

FIG. 4: illustrates various attachment configurations.

### DETAILED DESCRIPTION OF THE PREFERRED EMBODIMENTS OF THE INVENTION

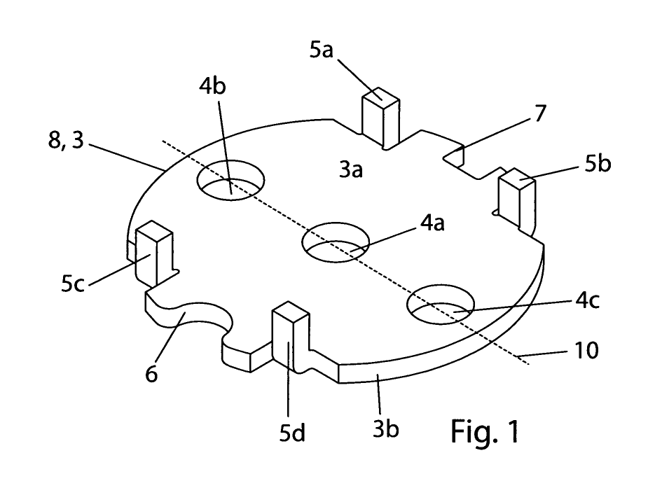

FIG. 1 illustrates the base plate 3, manufactured evidently as a stamped part, wherein the outer contour of the base plate 3 including the three mounting bore holes 4a-c is cut out of a flat piece of sheet metal in a single process step and simultaneously the four positioning ears 5a, b in this case are folded out of the main plane 9 of the base plate 3 in the same direction by 88° to 92°, in particular by 90° or slightly more.

Between the two respective positioning ears disposed closer to one another, 5a, b on the one hand side and 5c, d on the other hand side, the outer contour of the base plate 3 protrudes further outwards and in the one case includes a rectangular recess in the outer contour as a preliminary marker 7 and in the other case the outer contour of the base plate includes an approximately semi circular recess as an assembly marker 6.

The three mounting bore holes 4a-c are disposed on the center line 10 between the two pairs of positioning ears 5a, b and 5c, d, wherein the one mounting bore hole 4a is disposed centrally, thus in the center of the enveloping circle 2, which is partially formed by the circle segment shaped outer contour of the base plate 3, which does not protrude beyond the enveloping circle, while the other two mounting bore holes 4b, c are disposed symmetrical to the mounting bore hole 4a on opposite sides from one another.

Thus, the base plate 3 is configured symmetrical to the center line 10, besides the different shapes of the preliminary marker 7 and the assembly marker 6.

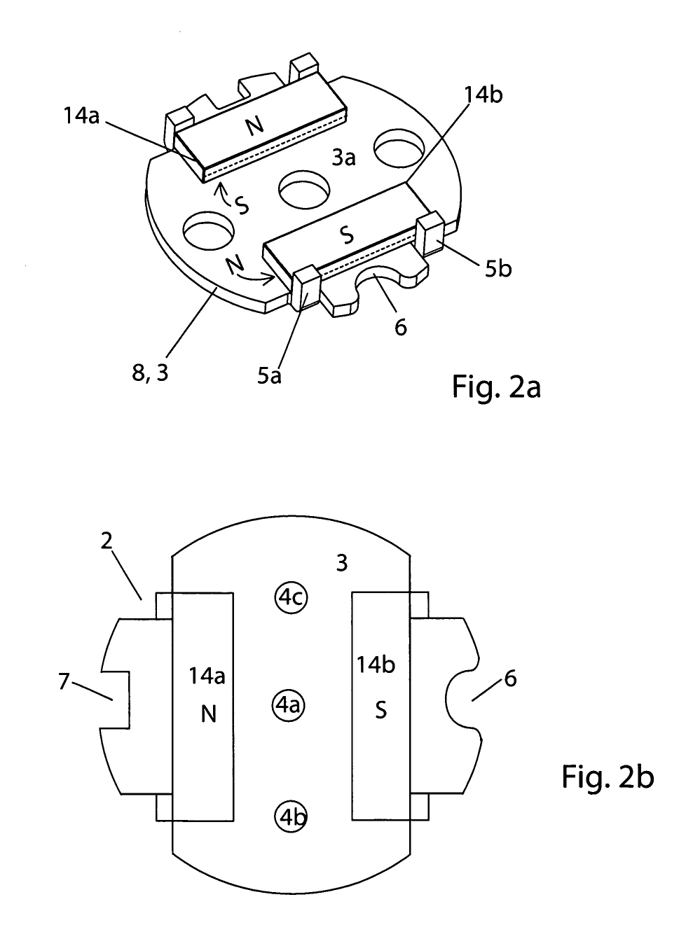

FIG. 2 illustrates the base plate 3, onto whose top side 3a, which is the side towards which the positioning ears 5a-d are folded, the two cuboid-shaped encoder magnets 14a, b are glued, so that the encoder magnets respectively contact the two positioning ears 5a, b or 5c, d, which are respectively disposed closer to one another, with the outsides of the encoder magnets, and so that the encoder magnets contact the top side 3a of the base plate 3 with their flat sides, thus with their sides with the largest surface area, and the encoder magnets and are glued to the top side 3a.

Thus, the positioning ears 5a, b provide form locked positioning for the encoder magnets 14a, b in one spatial direction, namely radially outwards, thus with the polar axis perpendicular to the base plate and in fact with the north pole of one magnet oriented upward and the south pole of the other magnet oriented upward, while the magnets are only secured in other two spatial directions by bonding them onto the base plate 3.

In FIG. 2c, right half, illustrates in a strongly exaggerated manner that the positioning ear 5b is folded up from the main plane of the base plate 3 preferably by more than 90°, so that the ensuing interior angle, in which the encoder magnet is applied, e.g. only has 88° and thus, the encoder magnet only contacts the positioning ear 5b with the upper edge of the encoder magnet and with its entire lateral surface.

Thus, the positioning ears 5a, b form a form locked positioning for the encoder magnets 14a, b in one spatial direction, thus radially towards the outside, while the safety is only provided through friction locking relative to the base plate 3 in the other two spatial directions.

In order for the encoder magnets to be arranged with the correct pole orientation during gluing, the preliminary marker 7 is fabricated between the ears in one of the two pairs 5c, d of positioning ears, wherein the preliminary marker is only relevant for applying the magnets.

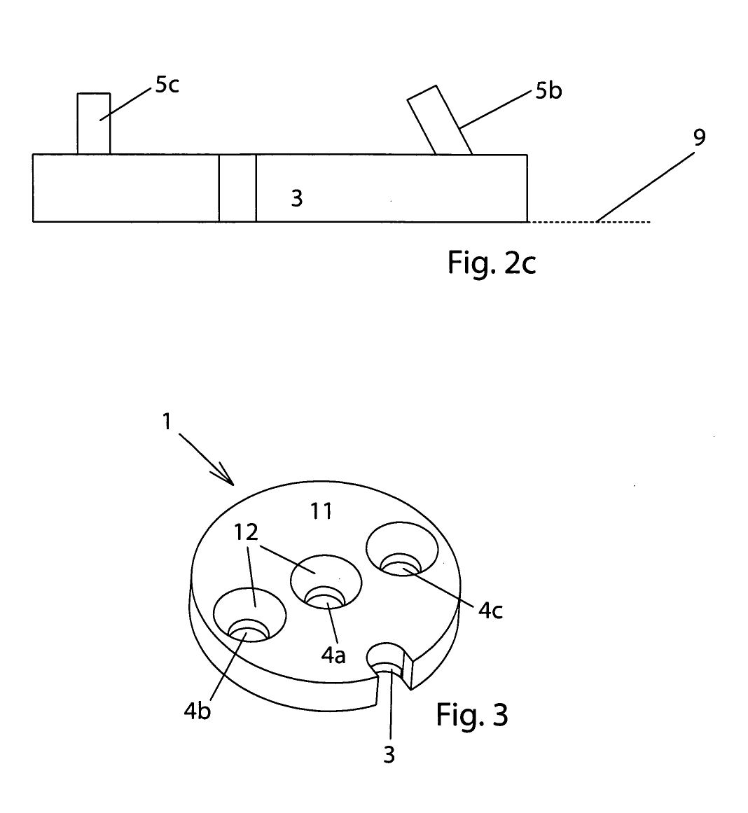

After curing of the bonding for the encoder magnets 14a, b, the base plate 3 with the encoder magnets 14a, b is inserted into a mold and encased with plastic material 11 through injection molding so that the finished encoder magnet is created as illustrated in FIG. 3.

Thus, the entire top side 3a of the base plate 3 is covered with plastic material 11, except for an edge portion 12 about the mounting bore holes 4a-c, which is left open in order to be able to apply the bolt head of a mounting bolt 13 from above at this location.

Also the preliminary marker 7 is filled in completely with plastic material 11, as well as the entire portion between the outer contour of the base plate 3 and the enveloping circle 2, with the exception of the assembly marker 6.

Since this semi-circular assembly marker 6 in the outer circumference of the finished position encoder 1 serves the purpose of fixating the position encoder with the correct magnet orientation to a different component, in that an ear (not illustrated) of the other component can extend into the recess of the assembly marker 6.

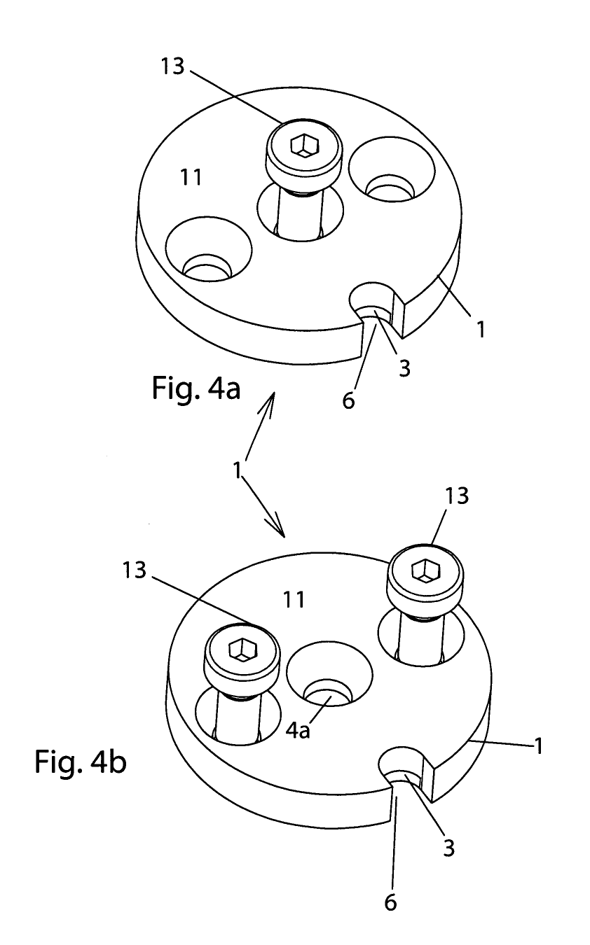

As illustrated in FIGS. 4a and b, the position encoder 3, which has the shape of a flat, round disc, can be fixated at another component in at least two different ways.

Either by bolting down with a single mounting bolt 13 through the central mounting bore hole 4a. Then, however, a form locked torsion safety e.g. through engagement with the assembly marker 6 is very helpful.

The central threaded connection is generally used when mounting a position encoder 1 to the face of a circular shaft.

The other option is to respectively thread a mounting bolt 13 through the two eccentric mounting bore holes 4b, c into the supporting component, wherein a rotation safety for the circular position encoder 1 is provided at the same time. Thus, the assembly marker 6 is only used for correct orientation when mounting the threaded connection.

What is claimed is:

1. A magnetic position encoder (1) for actuating magnetic angle sensors, comprising:
a base plate (3); and
at least one mounting bore hole (4) therein; at least one encoder magnet (14a), which is disposed on the base plate (3), wherein the base plate 93) is a shaped part made from ferromagnetic material.

2. The position encoder according to claim 1, wherein the base plate (3) is made from sheet metal.

3. The position encoder according to claim 1, wherein the base plate (3) is made from magnetically conductive material, in particular ferromagnetic steel.

4. A magnetic position encoder (1) for actuating magnetic angle sensors with preferably encoder magnets (14a, b), which are positioned opposite one another with respect to the center of a base plate (3), according to claim 1, wherein the base plate (3) comprises a central mounting bore hole (4a) and at least one, preferably at least two eccentric mounting bore holes (4b, c), which are disposed symmetrically opposite to one another with respect to the central mounting bore hole (4a), wherein the eccentric mounting bore holes have in particular the same diameter as the central mounting bore hole (4a).

5. The position encoder according to claim 4, wherein the polar axis of the encoder magnet (14a) is disposed in transversal direction, in particular perpendicular to the main plane (9) of the base plate (3).

6. The position encoder according to claim 4, wherein the particularly two encoder magnets (14a, b) are configured as elongated cuboids and are disposed in particular parallel to the center line defined by the at least one eccentric mounting bore hole.

7. The position encoder according to claim 4, wherein the two encoder magnets (14a, b) are configured as elongated cuboids and are disposed parallel to the center line with their largest extension.

8. The position encoder according to claim 4, wherein the encoder magnets (14a, b) contact positioning ears (5a-d), which are folded up from the main plane (9) of the base plate (3), in particular folded by 90° or more and which protrude upward from the edge portion of the base plate.

9. The position encoder according to claim 4, wherein the encoder magnets (14a, b) are glued to the top side (3a) of the base plate (3).

10. The position encoder according to claim 4, wherein a base body, in particular the base plate (3) comprises a form locked or visible magnetic assembly marker (6), which is also visible from the top side of the base plate (3) and not covered by the magnet.

11. The position encoder according to claim 10, wherein the base body additionally comprises a preliminary marker (7), which are not identical with respect to their shapes and are disposed in particular on sides opposite from one another with respect to the center line (10).

12. The position encoder according to claim 11, wherein the assembly marker (6) and the preliminary marker (7) are recesses in the circumference line of the base plate (3) or ears protruding from the circumference line of the base plate.

13. The position encoder according to claim 1, wherein an injection molded plastic encasement (11) is made from a transparent plastic material.

14. The position encoder according to claim 13, wherein the injection molded plastic encasement envelops the narrow sides (3b) and the top side (3a) of the base body, in particular of the base plate (2), and the encoder magnets (14a, b).

15. The position encoder according to claim 14, wherein the injection molded plastic encasement (11) is made from a transparent plastic material.

16. The position encoder according to claim 13, wherein the injection molded plastic encasement envelops the narrow sides (3b) and the top side (3a) of the base body, in particular of the base plate (2) including the encoder magnets (14a, b).

17. The position encoder according to claim 12, wherein the support ears extend only in the front and the rear end portion of the longitudinal extension of the magnet and extend at the most over 15%, preferably at the most over 10% of the longitudinal extension of the encoder magnet (14a, b) for each support ear.
